(19) United States
(12) Patent Application Publication
(10) Pub. No.: US 2025/0358739 A1
(43) Pub. Date: Nov. 20, 2025

(54) CELL SELECTION FOR INITIAL ACCESS

(71) Applicant: Nokia Technologies Oy, Espoo (FI)

(72) Inventors: Ahlem KHLASS, Nozay (FR); Daniela LASELVA, Klarup (DK); Jorma Johannes KAIKKONEN, Oulu (FI)

(73) Assignee: Nokia Technologies Oy, Espoo (FI)

(21) Appl. No.: 18/870,880

(22) PCT Filed: Jun. 6, 2022
(86) PCT No.: PCT/EP2022/065287

§ 371 Date: Dec. 2, 2024

(51) Int. Cl. H04W 52/02; H04W 48/20

(52) U.S. Cl. CPC H04W 52/0229; H04W 48/20

(57) ABSTRACT

This document discloses a solution for selecting a cell for initial access. According to an aspect, a method comprises: camping in a first cell and detecting a second cell that is in a sleep state; acquiring an initial access configuration mapping traffic types with sleep states and with a cell for initial access; acquiring data for uplink transmission; if a traffic type of the data is a first traffic type and the sleep state of the second cell is a first sleep state, transmitting a wake-up signal to the second cell, transmitting an initial access message to the second cell, and transmitting the data via the second cell; if the traffic type of the data is a second traffic type different from the first traffic type and if the sleep state of the second cell is a second sleep state, transmitting a wake-up signal to the second cell, transmitting an initial access message to the second cell, and transmitting the data via the second cell; and under another condition defined in the initial access configuration and based on the traffic type and the sleep state of the second cell, transmitting an initial access message to the first cell and transmitting the data via the first cell.

### FIELD

Various embodiments described herein relate to the field of wireless communications and, particularly, to selecting a cell for initial access of a terminal device.

### BACKGROUND

Power consumption of terminal devices of wireless communication systems has been one focus area in development of the wireless communication systems. The power consumption of the network infrastructure and, particularly, a radio access network is also an important factor. There exist some methods for reducing the power consumption, such as relaxed transmission of signalling information by an access node, which allows for temporary shut down of a transmitter circuitry of the access node. Some wireless systems enable the access node to enter a sleep state where it disables at least some functions in order to save power. A sleeping access node can be woken up for communicating with a terminal device. However, a decision logic is required for determining whether or not to wake up a sleeping cell in case uplink data needs to be transmitted.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus for apparatus for a terminal device, comprising means for performing: camping in a first cell and detecting a second cell that is in a sleep state; acquiring an initial access configuration mapping traffic types with sleep states and with a cell for initial access; acquiring data for uplink transmission; if a traffic type of the data is a first traffic type and the sleep state of the second cell is a first sleep state, transmitting a wake-up signal to the second cell, transmitting an initial access message to the second cell, and transmitting the data via the second cell; if the traffic type of the data is a second traffic type different from the first traffic type and if the sleep state of the second cell is a second sleep state, transmitting a wake-up signal to the second cell, transmitting an initial access message to the second cell, and transmitting the data via the second cell; and under another condition defined in the initial access configuration and based on the traffic type and the sleep state of the second cell, transmitting an initial access message to the first cell and transmitting the data via the first cell.

In an embodiment, the means are configured to determine a strength of a reference signal received from the second cell while the second cell is in the sleep state, to transmit the wake-up signal to the second cell, if the strength of the reference signal is above a threshold, and to transmit the initial access message to the first cell and to transmit the data via the first cell, if the strength of the reference signal is below the threshold.

In an embodiment, the means are configured to transmit the initial access message to the first cell and to transmit the data via the first cell, if the traffic type is a third traffic type, and wherein the first traffic type is associated with a first latency requirement, the second traffic type is associated with a second latency requirement, and the third traffic type is associated with a third latency requirement defining more strict latency requirement than the first traffic type and the second traffic type.

In an embodiment, the means are configured to transmit the initial access message to the first cell and to transmit the data via the first cell, if the sleep state is a third sleep state, and wherein the first sleep state is associated with a first wake-up delay defining a delay it takes for the second cell to wake up from the sleep state, wherein the second sleep state is associated with a second wake-up delay that is shorter than the first wake-up delay, and wherein the third sleep state is associated with a third wake-up delay that is longer than the first wake-up delay and the second wake-up delay.

In an embodiment, the means are configured to transmit the initial access message and to transmit the data via the first cell, if the traffic type is the second traffic type and if the sleep state is the first sleep state.

In an embodiment, the initial access configuration provides at least the following information:

| | | Cell to Send Initial |
|---|---|---|
| Set of Traffic Types | Sleep State | Access Message |
| First set of traffic | First sleep | Second cell |
| types, including the | state | |
| first traffic type | | |
| Second set of traffic | Second sleep | Second cell |
| types, including first | state | |
| traffic type and second | | |
| traffic type | | |
| Third set of traffic | Any sleep | First cell |
| types, excluding first | state | |
| traffic type and second | | |
| traffic type | | |

In an embodiment, the means are configured to determine a traffic load in the first cell and, if the traffic load is above a threshold, to transmit the wake-up signal and the initial access message to the second cell, and to transmit the data via the second cell.

In an embodiment, the means are configured to determine a strength of a reference signal received from the first cell while the second cell is in the sleep state, to transmit the wake-up signal to the second cell, if the strength of the reference signal is below a threshold, and to transmit the initial access message to the first cell and to transmit the data via the first cell, if the strength of the reference signal is above the threshold.

In an embodiment, at least some communication functions of the second cell are not available to the apparatus during the sleep state.

In an embodiment, the initial access message transmitted to the second cell comprises the wake-up signal.

In an embodiment, the means are configured to receive the initial access configuration from the first cell.

In an embodiment, the means are configured to transmit, upon selecting the second cell for the initial access, a wake-up signal to the second cell before transmitting the initial access message to the second cell.

In an embodiment, the means are configured to receive the initial access configuration from the second cell before the second cell enters the sleep state.

According to an aspect, there is provided an apparatus comprising means for performing: acquiring an initial access configuration mapping traffic types with sleep states and with a cell for initial access; transmitting the initial access configuration; and receiving from a terminal device an initial access message and uplink data.

In an embodiment, the means are configured to trigger entering a sleep state and, in response to the triggering, to transmit the initial access configuration before entering the sleep state.

In an embodiment, the means comprise at least one processor and at least one memory including computer program code, the at least one memory and computer program code configured to, with the at least one processor, cause the performance of the apparatus.

According to an aspect, there is provided a method comprising: a terminal device camping in a first cell and detecting a second cell that is in a sleep state; the terminal device acquiring an initial access configuration mapping traffic types with sleep states and with a cell for initial access; the terminal device acquiring data for uplink transmission; if a traffic type of the data is a first traffic type and the sleep state of the second cell is a first sleep state, the terminal device transmits a wake-up signal to the second cell, transmits an initial access message to the second cell, and transmits the data via the second cell; if the traffic type of the data is a second traffic type different from the first traffic type and if the sleep state of the second cell is a second sleep state, the terminal device transmits a wake-up signal to the second cell, transmits an initial access message to the second cell, and transmits the data via the second cell; and under another condition defined in the initial access configuration and based on the traffic type and the sleep state of the second cell, the terminal device transmits an initial access message to the first cell and transmitting the data via the first cell.

In an embodiment, the method further comprises by the terminal device:
determining a strength of a reference signal received from the second cell while the second cell is in the sleep state,
transmitting the wake-up signal to the second cell, if the strength of the reference signal is above a threshold, and
transmitting the initial access message to the first cell, and transmitting the data via the first cell, if the strength of the reference signal is below the threshold.

In an embodiment, the terminal device transmits the initial access message to the first cell and transmits the data via the first cell, if the traffic type is a third traffic type, and wherein the first traffic type is associated with a first latency requirement, the second traffic type is associated with a second latency requirement, and the third traffic type is associated with a third latency requirement defining more strict latency requirement than the first traffic type and the second traffic type.

In an embodiment, the terminal device transmits the initial access message to the first cell and transmits the data via the first cell, if the sleep state is a third sleep state, and wherein the first sleep state is associated with a first wake-up delay defining a delay it takes for the second cell to wake up from the sleep state, wherein the second sleep state is associated with a second wake-up delay that is shorter than the first wake-up delay, and wherein the third sleep state is associated with a third wake-up delay that is longer than the first wake-up delay and the second wake-up delay.

In an embodiment, the terminal device transmits the initial access message and transmits the data via the first cell, if the traffic type is the second traffic type and if the sleep state is the first sleep state.

In an embodiment, the initial access configuration provides at least the following information:

| | | Cell to Send Initial |
|---|---|---|
| Set of Traffic Types | Sleep State | Access Message |
| First set of traffic | First sleep | Second cell |
| types, including the | state | |
| first traffic type | | |
| Second set of traffic | Second sleep | Second cell |
| types, including first | state | |
| traffic type and second | | |
| traffic type | | |
| Third set of traffic | Any sleep | First cell |
| types, excluding first | state | |
| traffic type and second | | |
| traffic type | | |

In an embodiment, the terminal device determines a traffic load in the first cell and, if the traffic load is above a threshold, transmits the wake-up signal and the initial access message to the second cell, and transmits the data via the second cell.

In an embodiment, the terminal device:
determines a strength of a reference signal received from the first cell while the second cell is in the sleep state,
transmits the wake-up signal to the second cell, if the strength of the reference signal is below a threshold, and
transmits the initial access message to the first cell and transmits the data via the first cell, if the strength of the reference signal is above the threshold.

In an embodiment, at least some communication functions of the second cell are not available to the terminal device during the sleep state.

In an embodiment, the initial access message transmitted to the second cell comprises the wake-up signal.

In an embodiment, the terminal device receives the initial access configuration from the first cell.

In an embodiment, the terminal device transmits, upon selecting the second cell for the initial access, a wake-up signal to the second cell before transmitting the initial access message to the second cell.

In an embodiment, the terminal device receives the initial access configuration from the second cell before the second cell enters the sleep state.

According to an aspect, there is provided a method comprising: acquiring, by an access node, an initial access configuration mapping traffic types with sleep states and with a cell for initial access; transmitting, by the access node, the initial access configuration; and receiving, by the access node from a terminal device, an initial access message and uplink data.

In an embodiment, the access node triggers entering a sleep state and, in response to the triggering, transmits the initial access configuration before entering the sleep state.

According to an aspect, there is provided a computer program product embodied on a computer-readable medium and comprising a computer program code readable by a computer, wherein the computer program code configures the computer to carry out a computer process comprising: acquiring an initial access configuration mapping traffic types with sleep states and with a cell for initial access; transmitting the initial access configuration; and receiving from a terminal device an initial access message and uplink data.

According to an aspect, there is provided a computer program product embodied on a computer-readable medium and comprising a computer program code readable by a computer, wherein the computer program code configures the computer to carry out a computer process comprising: camping in a first cell and detecting a second cell that is in a sleep state; acquiring an initial access configuration mapping traffic types with sleep states and with a cell for initial access; acquiring data for uplink transmission; if a traffic type of the data is a first traffic type and the sleep state of the second cell is a first sleep state, transmitting a wake-up signal to the second cell, transmitting an initial access message to the second cell, and transmitting the data via the second cell; if the traffic type of the data is a second traffic type different from the first traffic type and if the sleep state of the second cell is a second sleep state, transmitting a wake-up signal to the second cell, transmitting an initial access message to the second cell, and transmitting the data via the second cell; and under another condition defined in the initial access configuration and based on the traffic type and the sleep state of the second cell, transmitting an initial access message to the first cell and transmitting the data via the first cell.

### LIST OF DRAWINGS

Embodiments are described below, by way of example only, with reference to the accompanying drawings, in which

FIGS. 1 and 2 illustrate wireless communication scenarios to which some embodiments of the invention may be applied;

FIG. 3 illustrates a flow diagram of a cell selection process according to an embodiment;

FIGS. 4 to 6 disclose various embodiments of the process of FIG. 3, using various criteria in the cell selection process; and

FIG. 7 illustrates a flow diagram of cell selection logic according to an embodiment;

FIGS. 8 and 9 illustrate signalling diagram according to some embodiments; and

FIG. 10 and FIG. 11 illustrate block diagrams of apparatuses according to some embodiments.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100 and 102 configured to be in a wireless connection on one or more communication channels in a cell with an access node (such as (e/g) NodeB) 104 providing the cell. (e/g) NodeB refers to an eNodeB or a gNodeB, as defined in 3GPP specifications. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used not only for signalling purposes but also for routing data from one (e/g) NodeB to another. The (e/g) NodeB is a computing device configured to control the radio resources of communication system it is coupled to. The NodeB may also be referred to as a base station, an access point, an access node, or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications define two relay modes: out-of-band relay where same or different carriers may be defined for an access link and a backhaul link; and in-band-relay where the same carrier frequency or radio resources are used for both access and backhaul links. In-band relay may be seen as a baseline relay scenario. A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection. A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

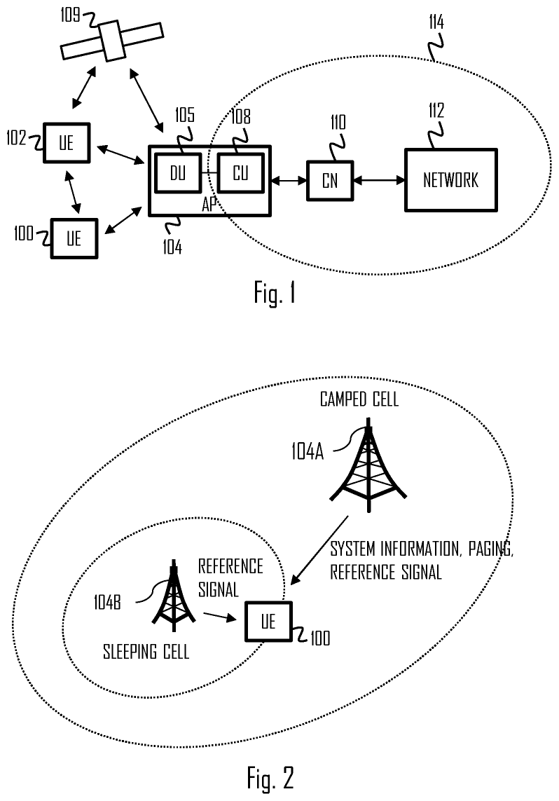

FIG. 2 illustrates a wireless communication scenario to which embodiments described below may be applied. The terminal device 100 may reside in a coverage area of cells operated by a first access node 104A and a second access node 104B. FIG. 2 illustrates a situation where the second access node 104B has disabled at least some of its functions and is in a sleep state, while the first access node 104A is in an active mode and capable of providing the terminal device with all supported communication services. Accordingly, the terminal device may choose a cell of the first access node 104A for camping in an idle or inactive state (camped cell). The cell(s) managed by the access node 104B may be called sleeping cells while the access node 104B is in the sleep state. An example of a difference between the sleep state and the active state may relate to transmissions. The first access node 104A may transmit full system information, be enabled for paging the terminal device 100, and transmit reference signals with short periodicity. The second access node 104B in the sleep state may have disabled transmission of system information and paging functions, and it may transmit reference signal with long periodicity. The reference signal transmission may comprise also information required to wake up the access node 104B, e.g. a cell identifier of the sleeping cell(s).

The camped cell may mean a cell where the terminal device is registered in an idle state or inactive state for paging, for example. Camping enables the terminal device to receive system information from the radio access network. When registered and if the terminal device wishes to establish a radio resource control (RRC) connection or resume a suspended RRC connection, it can do this by initially accessing the network on the control channel of the cell on which it is camped. If the network needs to send a message or deliver data to the registered terminal device, the radio access network knows a set of tracking areas where the terminal device is camped. It can then send a paging message for the terminal device on the control channels of all the cells in the corresponding tracking areas. The terminal device will then receive the paging message and can respond. Further, the camping enables reception of certain broadcasted information from the radio access network.

The sleeping cell and the camped cell may be co-located, e.g. provided by the same access node. As known in the art, an access node may provide multiple cells with different coverage areas, overlapping or non-overlapping.

As described in Background, upon detecting a need for uplink data transmission in a situation of FIG. 2, the terminal device may carry out a selection procedure to decide a cell for initial access and uplink data transmission. FIG. 3 illustrates an embodiment of a process for selecting a cell for the initial access. The process may be carried out by an apparatus for the terminal device 100. Referring to FIG. 3, the process comprises: camping (block 300) in a first cell and detecting a second cell that is in a sleep state; acquiring (block 302) an initial access configuration mapping traffic types with sleep states and with a cell for initial access; acquiring (block 304) data for uplink transmission and selecting (block 306) the cell for the initial access as follows:
if a traffic type of the data is a first traffic type and the sleep state of the second cell is a first sleep state, transmitting a wake-up signal to the second cell, transmitting the initial access message to the second cell, and transmitting the data via the second cell (block 310);
if the traffic type of the data is a second traffic type different from the first traffic type and if the sleep state of the second cell is a second sleep state, transmitting a wake-up signal to the second cell, transmitting the initial access message to the second cell, and transmitting the data via the second cell (block 310); and
under another condition defined in the initial access configuration and based on the traffic type and the sleep state of the second cell, transmitting an initial access message to the first cell and transmitting the data via the first cell (block 308).

The above-described selection logic enables efficient utilization of the access nodes for uplink transmissions. This is enabled by the initial access configuration that tells the terminal device under which conditions, in terms of the traffic type and the sleep state of the sleeping cell, the terminal device may wake up the sleeping cell and under which conditions to carry out the initial access via the camped first cell. This may reduce unnecessarily waking up the sleeping cell for services that can be accommodated by the camped cell and to reduce power consumption at the network level. It may also reduce a ping-pong effect from switching ON and OFF the sleeping cells.

The sleeping cell may be woken up by the terminal device via a wake-up procedure following the state-of-the-art. For example, 5G and IEEE 802.11 specifications support wake-up radio (WUR) procedures, and the actual wake-up procedure may be design according to similar principles. The wake-up procedure may include the terminal device transmitting a wake-up signal to the sleeping cell, the wake-up signal comprising a cell identifier of the sleeping cell. After the sleeping cell has woken up and is transmitting system information, the terminal device may transmit the initial access message to the respective access node, e.g. a random access request message. Thereafter, a conventional connection establishment (e.g. radio resource control, RRC, connection establishment) and uplink data transmission may follow.

Blocks 300 and 302 may be carried out in arbitrary order. For example, the initial access configuration may be acquired under various situations, as described below.

The data may comprise payload data (application layer data) and/or it may comprise signaling data.

With respect to the sleep state, the access node may assume one of multiple supported sleep states. Each sleep state may be associated with disabling a certain number of functions and hardware resources in the access node. For example, the sleeping cell may be in one of the following sleep states:
Micro sleep, symbol-level sleep: shut down a power amplifier for a symbol carrying neither data nor signaling information, transmit reference signal with normal or slightly longer-than-normal periodicity;
Mini sleep, radio frame-level sleep (10 ms): shut down . . . ; transmit a reference signal with long periodicity;
Light sleep, second-level sleep (e.g. 1 second sleep): partially shut down a baseband circuitry, transmit a reference signal with long periodicity.
Deep sleep, tens of second-level sleep (e.g. 10-30 seconds): shut down the baseband circuitry and radio transmitter chain.
Standby/shutdown, wake-up time 1-2 min; cell does not transmit synchronization signal blocks (SSBs) and/or system information blocks (SIBs); the cell is switched off or deactivated.

With respect to the different sleep states listed above, the following principle can be observed. When moving from a lighter to deeper sleep state, additional hardware components may be shut down until reaching the complete cell shutdown (i.e. cell deactivated). Additionally or alternatively, time interval between consecutive periodic broadcasts may be increased. It should be noted that the described hardware components in each sleep state are just examples on how the respective sleep states could be defined. Further, different systems may implement different numbers of different sleep states, e.g. one system may employ all the sleep states listed above while another system may employ a subset of the listed sleep states (omit one or more of the listed sleep states such as the mini sleep state).

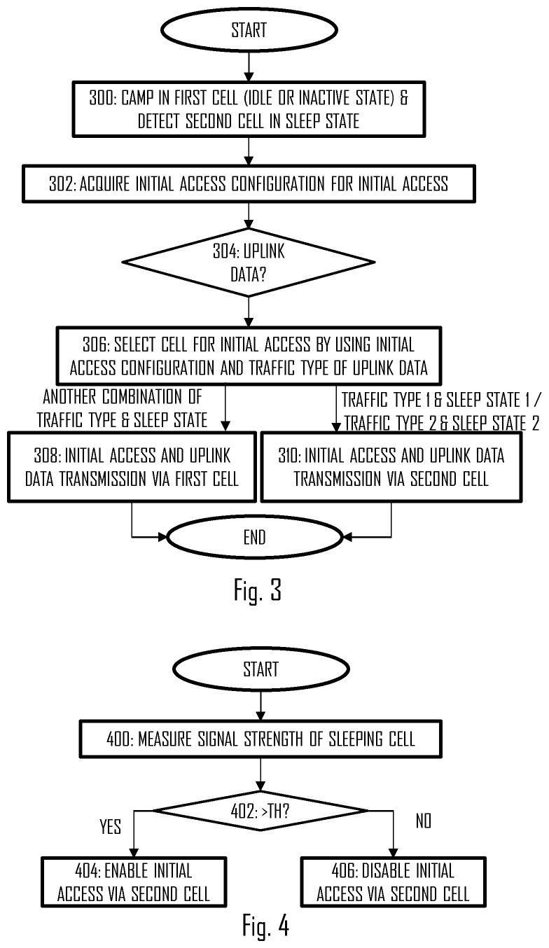

As described above in connection with FIG. 2, the sleeping cell may still transmit the reference signals enabling the terminal device to detect the sleeping cell and to measure a signal strength of the reference signals. In an embodiment, the terminal device determines a strength of a reference signal received from the second cell while the second cell is in the sleep state, and transmits the wake-up signal to the second cell, if the strength of the reference signal is above a threshold. FIG. 4 illustrates a flow diagram of such a procedure. Referring to FIG. 4, the terminal device may measure the signal strength of the reference signal(s) received from the sleeping cell in block 400. The signal strength may be provided in the form of a reference signal reception power (RSRP), signal-to-interference-plus-noise ratio (SINR), a received signal strength indicator, or another equivalent metric known in the art. In block 402, the signal strength is compared with a threshold. If the signal strength is greater than the threshold, the terminal device may enable the initial access via the second cell. For example, the terminal device may resume the process of FIG. 3 to block 306. If the signal strength is below the threshold, the terminal device may disable the initial access via the second cell, e.g. proceed from block 304 directly to block 308.

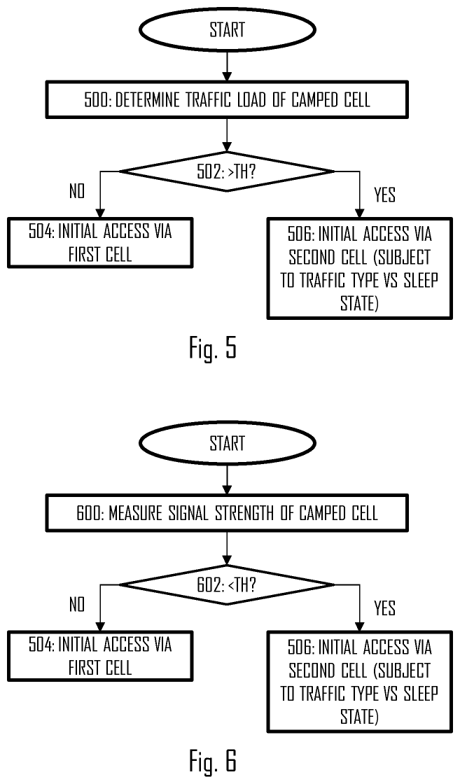

Yet another criterion for selecting the cell for initial access may be the traffic load in the camped cell. In an embodiment, the terminal device determines the traffic load in the first (camped) cell and, if the traffic load is above a threshold, transmits the wake-up signal and the initial access message to the second (sleeping) cell, and also transmits the data via the second cell. FIG. 5 illustrates such a procedure for the terminal device. Referring to FIG. 5, the terminal device determines the traffic load of the camped cell in block 500. The camped cell may report the traffic load via the broadcasted system information, in which case it is straightforward for the terminal device to read the traffic load. The traffic load may be reported via various metric, e.g. in terms of latency provided by the access node or an amount of free (unallocated) resources with respect to allocated resources. Other metrics can be envisaged. In another solution, the terminal device may measure the amount of traffic between the access node 104A of the camped cell and other terminal devices served by the access node 104A. In block 502, the terminal device compares the traffic load with a threshold. In case the comparison indicates that the traffic load in the camped cell is above the threshold, the terminal device may enable the initial access via the second (sleeping) cell. For example, the terminal device may resume the process of FIG. 3 to block 306. If the comparison indicates that the traffic load is below the threshold, the terminal device may disable the initial access via the second cell, e.g. proceed from block 304 directly to block 308.

In an embodiment, the terminal device determines a strength of a reference signal received from the first (camped) cell while the second cell is in the sleep state, transmits the wake-up signal to the second cell, if the strength of the reference signal is below a threshold, and transmits the initial access message to the first cell and transmits the data via the first cell, if the strength of the reference signal is above the threshold. FIG. 6 illustrates an embodiment of such a procedure for the terminal device. Referring to FIG. 6, the terminal device measures and determines the signal strength of the reference signa(s) received from the camped cell. The signal strength may be provided in the form of any one of the above-described metrics. The terminal device then compares the determined signal strength with the threshold in block 602. If the signal strength is below the threshold, the terminal device may enable the initial access via the second cell. For example, the terminal device may resume the process of FIG. 3 to block 306. If the signal strength is greater than the threshold, the terminal device may disable the initial access via the second cell, e.g. proceed from block 304 directly to block 308.

The threshold used in block 602 may be the same described above in connection with FIG. 4, or it may have a different threshold value. For example, the threshold used in block 602 may be lower than the threshold used in block 402. When considering only the signal strength as the criterion for selecting the cell for the initial access, it means that the terminal device may prefer the camped cell over the sleeping cell, thus allowing the sleeping cell to sleep with a greater probability.

In an embodiment, the initial access message transmitted to the sleeping cell comprises the wake-up signal. In such an embodiment, a random access request message may serve as a wake-up signal for the sleeping cell. In another embodiment, the terminal device first transmits the wake-up signal that wakes up the sleeping second cell and, upon receiving system information from the second cell, the terminal device transmits the initial access message such as a random access request message. The initial access message transmitted to the camped cell may comprise a random access request message.

In an embodiment, the terminal device transmits the initial access message to the first cell and transmits the data via the first cell, if the traffic type is a third traffic type, wherein the first traffic type is associated with a first latency requirement, the second traffic type is associated with a second latency requirement, and the third traffic type is associated with a third latency requirement defining more strict latency requirement than the first traffic type and the second traffic type. In other words, high-priority traffic with strict latency requirements (requiring low latency) may be associated with the initial access via the camped cell in the initial access configuration.

In an embodiment, the terminal device transmits the initial access message and the data via the first cell, if the traffic type is the second traffic type and if the sleep state is the first sleep state. For example, if the traffic type is the second traffic type that sets up a stricter latency requirement and the first sleep state is the deep sleep state described above causing greater latency than the second sleep state, the terminal device may select the first (camped) cell for the initial access and the data transmission.

Let us then describe some embodiments of the initial access configuration using at least the traffic type and the sleep state of the sleeping cell. As described above, the initial access configuration may define, for various combinations of at least the traffic type and the sleep state, the cell to which the terminal device shall transmit the initial access message. The traffic type may be defined in terms of a service type or service identifier (such as a logical channel group identifier, logical channel identifier, data radio bearer identifier etc.), an access class or access category or a quality-of-service (QoS) class defining different access classes with different latency requirements, or another classification that may define different priority levels for the different traffic types. The sleep states may follow the above-described embodiments, for example. However, it should be noted that different systems may employ different configurations of different sleep states and the number of sleep states may be more or less than described above.

In an embodiment, the initial access configuration provides at least the following information:

TABLE 1

| | | Cell to Send Initial |
|---|---|---|
| Set of Traffic Types | Sleep State | Access Message |
| First set of traffic types, | First sleep state | Second cell |
| including the first traffic | e.g. light sleep | |
| type, e.g. file transfer | | |
| Second set of traffic | Second sleep state | Second cell |
| types, including first | e.g. mini sleep | |
| traffic type (file transfer) | | |
| and second traffic type, | | |
| e.g. music streaming | | |
| Third set of traffic types, | Any sleep state | First cell |
| excluding first traffic | | |
| type and second traffic | | |
| type, e.g. emergency data | | |

The Table above illustrates a following logic. The first traffic type is in this case associated with loose latency requirements such as the file transfer, and belongs to the first set of traffic types that may define various levels of such loose latency requirements. The second traffic type is in this case associated with stricter latency requirements such as the music streaming, and belongs to the second set of traffic types that may define various levels of such stricter latency requirements. The third traffic type is in this case associated with even stricter latency requirements such as the emergency data or video call, and belongs to the third set of traffic types that may define various levels of such very strict latency requirements. Since the latency requirement of the first set of traffic types is loose, the terminal device is allowed to wake-up the sleeping cell even in a case where the sleeping cell is in a deeper sleep sate such as the light sleep, deep sleep, or even standby state. In a case of stricter latency requirements, the terminal device may be allowed to wake up the sleeping cell only if the sleep state is one of the sleep state with a relatively short wake-up latency, e.g. the mini sleep or micro sleep. If the sleep state is the deep sleep or standby, the terminal device may be configured to transmit the initial access message to the camped first cell. In case of the third set of traffic types, the terminal device may be configured to access only a cell that is not in a sleep state and, as a consequence, the terminal device would send the initial access message to the first cell. Below, a more detailed initial access configuration table is provided.

TABLE 2

| | Sleep State | Cell to |
|---|---|---|
| | (in terms of | Send Initial |
| Set of Traffic Types | wake-up latency) | Access Message |
| Traffic with very low | Less than 1 minute | Sleeping cell |
| latency requirement | 1 minute or more | Camped cell |
| (background data | | |
| transfer) | | |
| Traffic with medium | Less than 1 second | Sleeping cell |
| latency requirement | 1 second or more | Camped cell |
| type (web browsing, | | |
| e-mail) | | |
| Traffic with strict | Less than 10 | Sleeping cell |
| latency requirement | milliseconds | |
| (video call) | 10 milliseconds | Camped cell |
| Traffic with very | or more | |
| strict latency | All sleep states | Camped cell |
| requirement (real-time | | |
| emergency data) | | |

Referring to the Table 2 above, the initial access configuration may define for each traffic type a sleep state threshold that serves as a boundary for selecting either the camped cell or the detected sleeping cell for the initial access. As described in the Table, the sleep state threshold is different for different traffic types. The sleep state threshold may be defined in terms of the sleep state directly or via an intermediate metric such as the wake-up delay. As illustrated in the Table, the highest priority traffic may always overrule the sleeping cell selection, thus avoiding cell reselection and accessing via the camped cell, thus providing the smallest latency.

As described above, the signal strength of the camped cell and/or the detected sleeping cell may serve as a further input to the cell selection. As described above, the signal strength may be used as the criterion on whether or not the sleeping cell can be considered at all. In another embodiment, the signal strength is incorporated into the selection logic, e.g. as provided below for a single traffic type. The same principle may be applied to other traffic types.

TABLE 3

| | Sleep State | | Cell to |
|---|---|---|---|
| Set of | (in terms of | Signal | Send Initial |
| Traffic Types | wake-up latency) | Strength | Access Message |
| Traffic with very | Less than 1 | CS: <TH1 | Sleeping cell |
| low latency | minute | SS: >TH2 | |
| requirement | | CS: <TH1 | Camped cell |
| (background data | | SS: <TH2 | |
| transfer) | | CS: >TH1 | Camped cell |
| | | SS: <TH2 | |
| | | CS: >TH1 | Sleeping cell |
| | | SS: >TH2 | |
| | 1 minute or more | CS: <TH1 | Sleeping cell |
| | | SS: >TH2 | |
| | | CS: <TH1 | Camped cell |
| | | SS: <TH2 | |
| | | CS: >TH1 | Camped cell |
| | | SS: <TH2 | |
| | | CS: >TH1 | Camped cell |
| | | SS: >TH2 | |

In the Table 3, CS refers to ‘camped cell’ while SS refers to ‘sleeping cell’. As illustrated in the Table above, the initial access configuration may provide rules for the terminal device to select the cell for the initial access per traffic type, per sleep state of the sleeping cell, and per signal strength of the camped cell and/or sleeping cell.

In a similar manner, the traffic load of the camped cell may be employed for the cell selection. Table below illustrates an embodiment for mapping the traffic load as an additional parameter to the cell selection. Again, the traffic load is illustrated for one traffic type, but the same principle can be applied to the other traffic types in an analogous manner.

TABLE 4

| | Sleep State | Traffic | Cell to |
|---|---|---|---|
| Set of | (in terms of | Load | Send Initial |
| Traffic Types | wake-up latency) | (TL) | Access Message |
| Traffic with very | Less than 1 | TL > TH3 | Sleeping cell |
| low latency | minute | TL < TH3 | Camped cell |
| requirement | 1 minute or more | TL > TH4 | Sleeping cell |
| (background data | | TL < TH4 | Camped cell |
| transfer) | | | |

As illustrated in the Table, the same or different traffic load threshold may be applied to the different sleep states. In the same manner, the same or different traffic load threshold may be applied to the different traffic types. In this manner, versatility to the cell selection for the initial access.

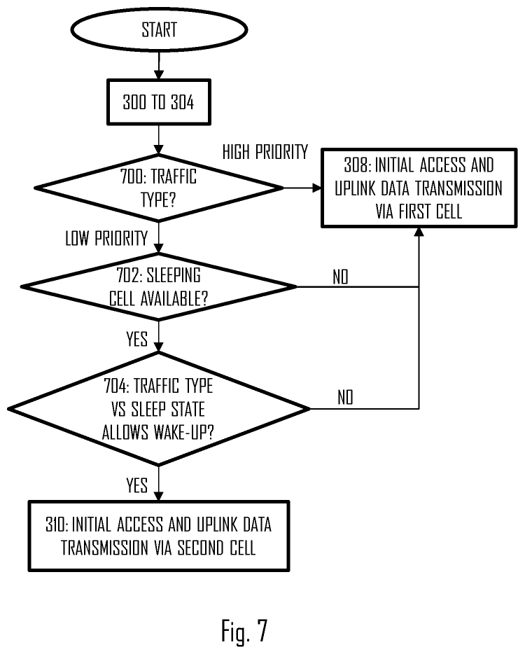

Let us then describe some embodiments of selection logic for the cell selection. FIG. 7 illustrates a flow diagram of an embodiment of the selection logic for the cell selection by the terminal device. The selection logic describes how the terminal device may employ the Tables above for selection the cell for the initial access. Referring to FIG. 7, blocks 300 to 304 may be carried out in the above-described manner. In block 700, the terminal device determines the traffic type of the data to be transmitted. As described above, the traffic type may be defined in terms of the QoS classification, latency requirement, channel identifier, or a data bearer identifier, for example. If the traffic type indicates that the data is high-priority data, the initial access and the data transmission may be carried out via the camped first cell (block 308). As described above, if the traffic type indicates the priority above a certain threshold, e.g. in Table 2 the highest-priority data traffic is always transmitted via the camped cell.

On the other hand, if the traffic type indicates low-priority traffic, e.g. traffic type that basically enables access via the sleeping cell in at least one of the sleeping states, the process may proceed to block 702 where it is determined whether or not a sleeping cell has been detected to be available for the initial access. If no sleeping is detected, the process may proceed to block 308 for the initial access via the camped cell. If at least one sleeping cell has been detected, the process may proceed to block 704 where the combination of the traffic type and the sleeping state of the detected cell(s) is searched from the initial access configuration, and the cell for the initial access is selected on the basis of the combination of at least the traffic type and the sleep state. If the combination of the traffic type and the sleep state is mapped to the camped cell in the initial access configuration, the process proceeds to block 308. If the combination of the traffic type and the sleep state is mapped to the sleeping cell in the initial access configuration, the process may proceed to block 310 and the wake-up of the sleeping cell.

In case there are multiple sleeping cells, the terminal device may select a sleeping cell with a sleep state that provides the fastest wake-up time. However, another criterion may be equally used for selecting one of the sleeping cells.

In case the initial access configuration defines a further criterion in addition to the combination of the traffic type and the sleep state, e.g. the traffic load or the signal strength of the sleeping cell and/or the camped cell, the same logic for using the initial access configuration may be used. For example, if the further criterion is the traffic load, the terminal device may determine a combination of the traffic type of the data, the sleep state of the sleeping cell, and the traffic load of the camped cell and determine whether the initial access configuration maps the combination to the sleeping cell or the camped cell and, then, selects the respective cell for the initial access. The same logic may be applied to the signal strength: the terminal device may determine a combination of the traffic type of the data, the sleep state of the sleeping cell, and the signal strength of the camped cell and/or the sleeping cell and determine whether the initial access configuration maps the combination to the sleeping cell or the camped cell and, then, selects the respective cell for the initial access.

In an embodiment, the signal strength of the sleeping cell is measured on the basis of a signal strength of the camped cell and the known location of the access node 104B with respect to the access node 104A. As known in the art, modern communication systems transmit signals as narrow beams such that the coverage area of a cell is covered by a combined coverage area of multiple such narrow beams. The terminal device may thus use the information on the measured beam, e.g. a beam identifier, the signal strength of the measured beam, and the location of the access node 104B with respect to the access node 104A to determine the distance between the terminal device and the access node 104B.

Yet another criterion for the cell selection is the mobility of the terminal device. In case the mobility is above a threshold, e.g. the speed of the terminal device is above the threshold, the initial access configuration may specify that the terminal device shall carry out the initial access via the camped cell. If the mobility is below the threshold, the wake-up of the sleeping cell may be enabled according to any one of the above-described embodiments.

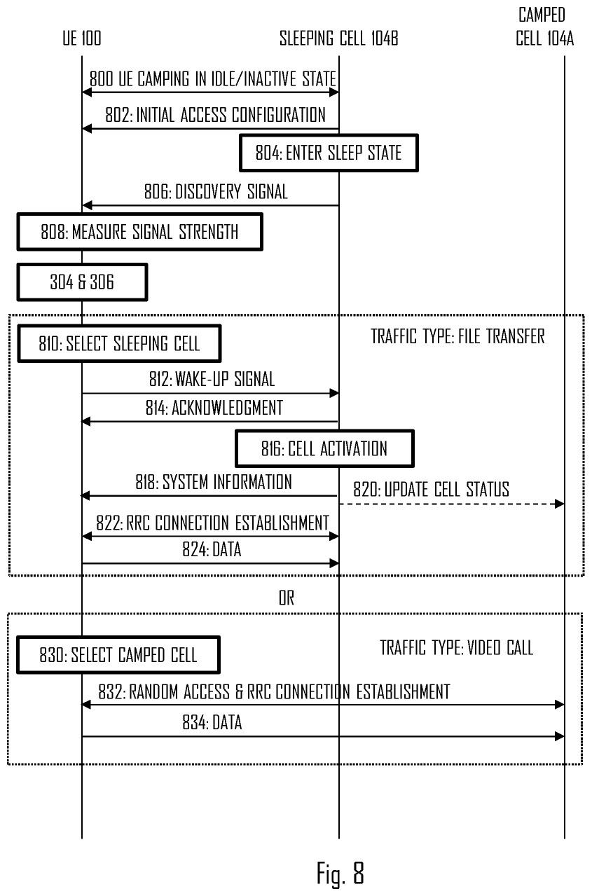

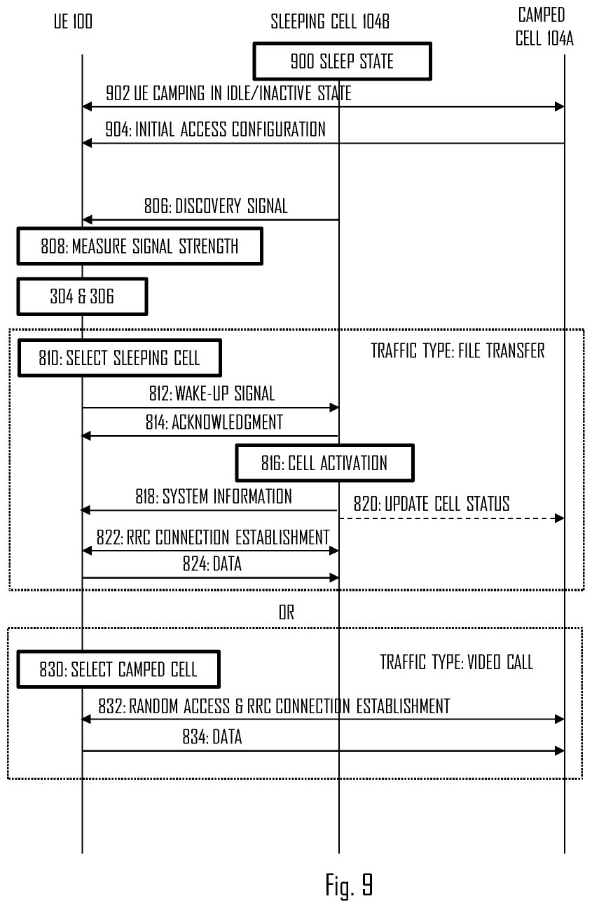

Although the terminal device performs the cell selection, it may be preferred that the radio access network or the system specifications provide the initial access configuration. In this manner, the behavior of the terminal device(s) is predictable. In an embodiment, the terminal device receives the initial access configuration from the sleeping cell before the sleeping cell enters the sleep state. FIGS. 8 and 9 illustrate signaling diagrams of procedures for configuring the initial access configuration and for the initial access. FIG. 8 illustrates an embodiment where the sleeping cell sends the initial access configuration before entering the sleep state and FIG. 9 illustrates an embodiment where the camped cell transmits the initial access configuration and the terminal device receives the initial access configuration from the camped cell.

Referring to FIG. 8, the initial situation may be such that the terminal device 100 camps in the second cell provided by the access node 104B (step 800). The terminal device may be in the idle state or the inactive state. Upon determining to enter the sleep state, or as a part of periodically transmitted system information, the sleeping cell may transmit the initial access configuration in step 802 via broadcast signaling, for example. Upon receiving the initial access configuration in step 802, the terminal device may store the initial access configuration. Thereafter, the access node 104B may apply a selected sleep state for the cell so that the cell becomes a sleeping cell (block 804).

In an embodiment, the access node 104B transmits, in connection with the initial access configuration in step 802 or as a part of different signaling information, a wake-up signal (WUS) configuration which includes WUS resources (in time/frequency) and/or a WUS sequence the terminal device may use for transmitting the wake-up signal.

Upon detecting that the cell managed by the access node 104B has entered the sleep state, the terminal device may perform cell selection and select to camp in the cell provided by the access node 104A (not shown), and the selected cell becomes the above-described camped cell.

As described, above, the sleeping cell may still transmit discovery signals including the reference signal and the cell identifier in the sleep state (step 806). The discovery signal may additionally comprise an information element indicating the sleep state of the sleeping cell. In this manner, the terminal device may detect the sleep state of the sleeping cell in the above-described embodiments. Another alternative is that the sleeping cell indicates the sleep state in step 802. Upon receiving the discovery signal, the terminal device may measure the signal strength of the discovery signal in block 808. In some embodiments, the terminal device may further measure the signal strength of a reference signal received from the camped cell of the access node 104A.

Thereafter, the terminal device performs the cell selection in 306 for uplink data to be transmitted. FIG. 8 illustrates both options: selecting the sleeping cell in block 810 and selecting the camped cell in block 830. Let us assume that the terminal device selects the sleeping cell, e.g. the uplink data is low-priority data such as file transfer. Upon selecting the sleeping cell in block 810, the terminal device may transmit the wake-up signal to the sleeping cell in the WUS resources configured by the sleeping cell (step 812). Since the access node 104B is monitoring the WUS resources in the sleep state, the access node 104B receives the wake-up signal and activates the sleeping cell in block 816. Block 816 may comprise powering up at least some circuitries of the access node 104B used for the cell that is woken up from the sleep state. The access node 104B may then acknowledge the wake-up and transmit system information in step 818. The system information may comprise certain system information required for the initial access message such as the random access request. Such information may comprise random access resources, for example.

The access node 104B may also inform neighboring access node(s) about its activation in step 820. This information may be provided through Xn/X2 information exchange and enables to ensure a coordination between the access nodes. The terminal device may wait for the cell activation before initiating connection establishment, e.g. the RRC connection establishment in step 822 via a random access procedure. Upon establishing the RRC connection, the uplink data may be transmitted via the cell woken up and the access node 104B in step 824.

Upon selecting the camped cell and the access node 104A in block 830, e.g. in case the traffic type is high-priority traffic type such as a video call, the terminal device may carry out a conventional connection establishment procedure in step 832 and transmit the uplink data via the camped cell and the access node 104A in step 834.

FIG. 9 illustrates a signaling diagram that mainly follows the steps of the embodiment of FIG. 8. As a consequence, the steps or blocks denoted by the same reference numbers as in FIG. 8 represent the same or substantially similar functions. The initial situation in the embodiment of FIG. 9 is that the terminal device camps in the cell provided by the access node 104A (step 902) while the access node has put its cell into the sleep state (block 900). In such a case, the terminal device may receive the initial access configuration from the camped cell in step 904 and store the initial access configuration. Thereafter, the procedure may continue in the above-described manner.

On the basis of the embodiments described above, there is provided a procedure for an access node of a cellular communication system. The access node may be the access node 104B that manages the sleeping cell or the access node 104A managing the camped active cell. Following the actions of the access node in FIGS. 8 and 9, the procedure for the access node may comprise: acquiring an initial access configuration mapping traffic types with sleep states and with a cell for initial access; transmitting (e.g. broadcasting) the initial access configuration; and receiving from a terminal device an initial access message and uplink data.

In an embodiment, the access node triggers entering the sleep state (e.g. a selected sleep state amongst multiple supported sleep states) and, in response to the triggering, transmits the initial access configuration before entering the sleep state.

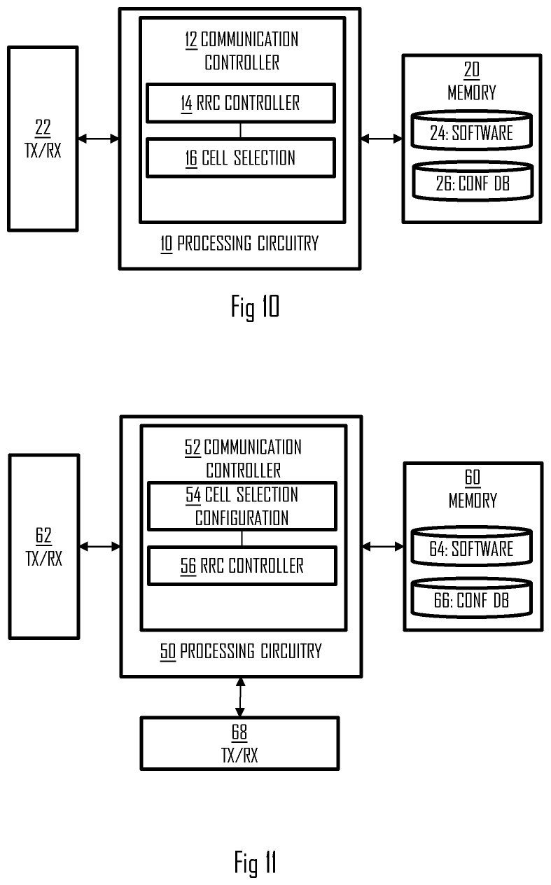

FIG. 10 illustrates an apparatus comprising means for carrying out the process of FIG. 3 or any one of the embodiments described above. The apparatus may comprise at least one processor 10 and at least one memory 20 including a computer program code (software) 24, wherein the at least one memory and the computer program code (software) are configured, with the at least one processor, to cause the apparatus to carry out the process of FIG. 3 or any one of its embodiments described above. The apparatus may be for the terminal device of the cellular communication system. The apparatus may be a circuitry or an electronic device realizing some embodiments of the invention in the terminal device. The apparatus carrying out the above-described functionalities may thus be comprised in the terminal device, e.g. the apparatus may comprise a circuitry such as a chip, a chipset, a processor, a micro controller, or a combination of such circuitries for the terminal device.

The memory 20 may be implemented using any suitable data storage technology, such as semiconductor-based memory devices, flash memory, magnetic memory devices and systems, optical memory devices and systems, fixed memory and removable memory. The memory may store a configuration database 26 and a computer program code 24 (software) configuring the operation of the one or more processors or processing circuitries of the apparatus. The configuration database may store the initial access configuration, whenever the initial access configuration is or becomes available to the apparatus.

In an embodiment, the apparatus comprises at least one processor, the at least one memory 20, and the computer program code that configure the apparatus to carry out the process of FIG. 3 or any one of the embodiments thereof. The at least one processor may comprise a communication controller 12. The communication controller 12 may comprise an RRC controller 14 configured to establish, manage, and terminate radio connections, e.g. the RRC connections. The RRC controller 12 may be configured, for example, to establish and reconfigure the RRC connections. The RRC controller may also control communication of the terminal device in the idle and inactive states, e.g. by configuring the apparatus to receive and process the system information and the reference signals from the access nodes.

The communication controller 12 may further comprise a cell selection circuitry 16 configured to carry out the cell selection process according to any one of the above-described embodiments on the basis of the initial access configuration.

The apparatus may further comprise a communication interface 22 comprising hardware and/or software for providing the apparatus with radio communication capability, as described above. The communication interface 22 may include, for example, an antenna, one or more radio frequency filters, a power amplifier, and one or more frequency converters. The communication interface 22 may comprise hardware and software needed for realizing the radio communications over the radio interface, e.g. according to specifications of an LTE or 5G radio interface.

FIG. 12 illustrates an apparatus comprising a processing circuitry, such as at least one processor, and at least one memory 60 including a computer program code (software) 64, wherein the at least one memory and the computer program code (software) are configured, with the at least one processor, to cause the apparatus to carry out functions of the access node 104A or 104B in blocks the process of FIG. 8 or 9. The apparatus may be configured to carry out at least transmission of the initial access configuration and reception of the initial access message based on the cell selection induced by the initial access configuration. The apparatus may be for the access node of the cellular network infrastructure. The apparatus may be a circuitry or an electronic device realizing some embodiments of the invention in the access node. The apparatus carrying out the above-described functionalities may thus be comprised in such a device, e.g. the apparatus may comprise a circuitry such as a chip, a chipset, a processor, a micro controller, or a combination of such circuitries for the access node. In other embodiments, the apparatus is the access node. The at least one processor or a processing circuitry may realize a communication controller 50 controlling communications with terminal devices over the radio interface in the above-described manner.

The communication controller 50 may comprise an RRC controller 56 configured to establish, manage, and terminate radio connections with terminal devices served by the access node. The RRC controller 56 may be configured, for example, to establish and reconfigure the RRC connections with the terminal devices. The RRC controller may carry out random access procedures for establishing the RRC connections and control the data transfer over the RRC connections.

The communication controller 50 may further comprise a cell selection configuration circuitry 54 configured to select parameters of the initial access configuration. For example, the cell selection configuration circuitry may be configured to select one or more of the above-described thresholds. The communication controller may control transmission of the initial access configuration, e.g. as a part of the broadcasted system information.

The memory 60 may be implemented using any suitable data storage technology, such as semiconductor-based memory devices, flash memory, magnetic memory devices and systems, optical memory devices and systems, fixed memory and removable memory. The memory 60 may comprise a configuration database 66 storing the initial access configuration currently applied.

The apparatus may further comprise a radio frequency communication interface 62 comprising hardware and/or software for providing the apparatus with radio communication capability with the terminal devices, as described above. The communication interface 62 may include, for example, an antenna array, one or more radio frequency filters, a power amplifier, and one or more frequency converters. The communication interface 62 may comprise hardware and software needed for realizing the radio communications over the radio interface, e.g. according to specifications of an LTE or 5G radio interface.

The apparatus may further comprise another communication interface 68 for communicating towards the core network. The communication interface may support respective communication protocols of the cellular communication system to enable communication with other access nodes, with other nodes of the radio access network, and with nodes in the core network and even beyond the core network. The communication interface 68 may comprise necessary hardware and software for such communications. For example, step 820 may be carried out over the communication interface 68.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 9, or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1. An apparatus for a terminal device, comprising at least one processor and at least one memory including computer program code, the at least one memory and computer program code configured to, with the at least one processor, cause the apparatus to perform:
camping in a first cell and detecting a second cell that is in a sleep state;
acquiring an initial access configuration mapping traffic types with sleep states and with a cell for initial access;
acquiring data for uplink transmission;
if a traffic type of the data is a first traffic type and the sleep state of the second cell is a first sleep state, transmitting a wake-up signal to the second cell, transmitting an initial access message to the second cell, and transmitting the data via the second cell;
if the traffic type of the data is a second traffic type different from the first traffic type and if the sleep state of the second cell is a second sleep state, transmitting a wake-up signal to the second cell, transmitting an initial access message to the second cell, and transmitting the data via the second cell; and
under another condition defined in the initial access configuration and based on the traffic type and the sleep state of the second cell, transmitting an initial access message to the first cell and transmitting the data via the first cell.

2. The apparatus of claim 1, wherein the apparatus is further caused to determine a strength of a reference signal received from the second cell while the second cell is in the sleep state, to transmit the wake-up signal to the second cell, if the strength of the reference signal is above a threshold, and to transmit the initial access message to the first cell and to transmit the data via the first cell, if the strength of the reference signal is below the threshold.

3. The apparatus of claim 1, wherein the apparatus is further caused to transmit the initial access message to the first cell and to transmit the data via the first cell, if the traffic type is a third traffic type, and wherein the first traffic type is associated with a first latency requirement, the second traffic type is associated with a second latency requirement, and the third traffic type is associated with a third latency requirement defining more strict latency requirement than the first traffic type and the second traffic type.

4. The apparatus of claim 1, wherein the apparatus is further caused to transmit the initial access message to the first cell and to transmit the data via the first cell, if the sleep state is a third sleep state, and wherein the first sleep state is associated with a first wake-up delay defining a delay it takes for the second cell to wake up from the sleep state, wherein the second sleep state is associated with a second wake-up delay that is shorter than the first wake-up delay, and wherein the third sleep state is associated with a third wake-up delay that is longer than the first wake-up delay and the second wake-up delay.

5. The apparatus of claim 1, wherein the apparatus is further caused to transmit the initial access message and to transmit the data via the first cell, if the traffic type is the second traffic type and if the sleep state is the first sleep state.

6. The apparatus of claim 1, wherein the initial access configuration provides at least the following information:

| | | Cell to Send Initial |
|---|---|---|
| Set of Traffic Types | Sleep State | Access Message |
| First set of traffic | First sleep | Second cell |
| types, including the | state | |
| first traffic type | | |
| Second set of traffic | Second sleep | Second cell |
| types, including first | state | |
| traffic type and second | | |
| traffic type | | |
| Third set of traffic | Any sleep | First cell |
| types, excluding first | state | |
| traffic type and second | | |
| traffic type | | |

7. The apparatus of claim 1, wherein the apparatus is further caused to determine a traffic load in the first cell and, if the traffic load is above a threshold, to transmit the wake-up signal and the initial access message to the second cell, and to transmit the data via the second cell.

8. The apparatus of claim 1, wherein the apparatus is further caused to determine a strength of a reference signal received from the first cell while the second cell is in the sleep state, to transmit the wake-up signal to the second cell, if the strength of the reference signal is below a threshold, and to transmit the initial access message to the first cell and to transmit the data via the first cell, if the strength of the reference signal is above the threshold.

9. The apparatus of any preceding-claim 1, wherein at least some communication functions of the second cell are not available to the apparatus during the sleep state.

10. The apparatus of claim 1, wherein the initial access message transmitted to the second cell comprises the wake-up signal.

11. The apparatus of claim 1, wherein the apparatus is further caused to receive the initial access configuration from the first cell.

12. The apparatus of claim 1, wherein the apparatus is further caused to transmit, upon selecting the second cell for the initial access, a wake-up signal to the second cell before transmitting the initial access message to the second cell.

13. The apparatus of claim 1, wherein the apparatus is further caused to receive the initial access configuration from the second cell before the second cell enters the sleep state.

14-16. (canceled)

17. A method comprising:
a terminal device camping in a first cell and detecting a second cell that is in a sleep state;
the terminal device acquiring an initial access configuration mapping traffic types with sleep states and with a cell for initial access;
the terminal device acquiring data for uplink transmission;
if a traffic type of the data is a first traffic type and the sleep state of the second cell is a first sleep state, the terminal device transmits a wake-up signal to the second cell, transmits an initial access message to the second cell, and transmits the data via the second cell;
if the traffic type of the data is a second traffic type different from the first traffic type and if the sleep state of the second cell is a second sleep state, the terminal device transmits a wake-up signal to the second cell, transmits an initial access message to the second cell, and transmits the data via the second cell; and
under another condition defined in the initial access configuration and based on the traffic type and the sleep state of the second cell, the terminal device transmits an initial access message to the first cell and transmitting the data via the first cell.

18. The method of claim 17, further comprising by the terminal device:
determining a strength of a reference signal received from the second cell while the second cell is in the sleep state,
transmitting the wake-up signal to the second cell, if the strength of the reference signal is above a threshold, and transmitting the initial access message to the first cell, and
transmitting the data via the first cell, if the strength of the reference signal is below the threshold.

19. The method of claim 17- or 18, wherein the terminal device transmits the initial access message to the first cell and transmits the data via the first cell, if the traffic type is a third traffic type, and wherein the first traffic type is associated with a first latency requirement, the second traffic type is associated with a second latency requirement, and the third traffic type is associated with a third latency requirement defining more strict latency requirement than the first traffic type and the second traffic type.

20. The method of claim 17, wherein the terminal device transmits the initial access message to the first cell and transmits the data via the first cell, if the sleep state is a third sleep state, and wherein the first sleep state is associated with a first wake-up delay defining a delay it takes for the second cell to wake up from the sleep state, wherein the second sleep state is associated with a second wake-up delay that is shorter than the first wake-up delay, and wherein the third sleep state is associated with a third wake-up delay that is longer than the first wake-up delay and the second wake-up delay.

21. The method of claim 17, wherein the terminal device transmits the initial access message and transmits the data via the first cell, if the traffic type is the second traffic type and if the sleep state is the first sleep state.

22. (canceled)

23. The method of claim 17, wherein the terminal device determines a traffic load in the first cell and, if the traffic load is above a threshold, transmits the wake-up signal and the initial access message to the second cell, and transmits the data via the second cell.

24. The method of claim 17, wherein the terminal device:
determines a strength of a reference signal received from the first cell while the second cell is in the sleep state,
transmits the wake-up signal to the second cell, if the strength of the reference signal is below a threshold, and
transmits the initial access message to the first cell and transmits the data via the first cell, if the strength of the reference signal is above the threshold.

25-33. (canceled)
